(19) United States
(12) Patent Application Publication
(10) Pub. No.: US 2012/0012190 A1
(43) Pub. Date: Jan. 19, 2012

(54) Valve system for releasing pressurized fluid

(76) Inventor: Gerald L. Barber, Greenville, SC (US)

(21) Appl. No.: 12/804,044

(22) Filed: Jul. 13, 2010

(51) Int. Cl. F16K 17/36; F16K 15/20

(52) U.S. Cl. 137/68.11; 137/223

(57) ABSTRACT

A valve system for releasing a pressurized fluid is provided that includes a housing that has a that defines an interior of the housing with at least one fluid escape aperture through the wall. A trigger member may be located in the interior of the housing and is accessible from outside of the housing. A plunger may be located in the interior of the housing and can move when the structural integrity of the trigger member changes. A container can be included that has pressurized fluid therein that acts against the plunger. The pressurized fluid is capable of exiting through the fluid escape aperture when the plunger changes position.

### FIELD OF THE INVENTION

The present invention relates generally to valve systems that are used for releasing pressurized fluid. More particularly, the present application involves a valve system that may be configured as an inflatable life preserver for use in inflating to provide buoyancy upon immersion in water.

### BACKGROUND

Life preservers are known that are initially provided in a deflated state and worn by a user either around the neck, waist, shoulders, chest, arm, or other body portion. The life preserver includes an electronic sensor that has a time delay circuit that is responsive to immersion in water. Upon immersion for a pre-selected interval, the sensor may activate an inflation gas present within the life preserver to effect inflation. Other applications that incorporate valves, besides life preservers, often include mechanical springs that are used to open or close the valve. For example, in a stop valve, a biasing spring is used to force a disk or other body against a seat that blocks the flow of fluid through a line. Once sufficient pressure is built within the line, the spring force of the biasing spring is overcome and the biasing spring compresses. Fluid may then flow through the line so that pressure within the line is relieved. Once the pressure drops below a certain level, the biasing force of the biasing spring is sufficient to once again force the disk against the seat to seal the valve. Although capable of working for their intended purposes, valve systems that employ electronic components and/or mechanical springs may be complex in design or otherwise limited in applicability. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a side cross-sectional view of a valve system with a plunger in a first position in accordance with one exemplary embodiment.

FIG. 2 is a side cross-sectional view of the valve system of FIG. 1 with a trigger member removed due to engagement with water.

FIG. 3 is a front view that is in partial cross-section of a valve system having a bladder and arranged as a life preserver in accordance with one exemplary embodiment.

FIG. 4 is a perspective view of a cap of the valve system.

FIG. 5 is a perspective view of a housing of the valve system.

FIG. 6 is a cross-sectional view of the valve system in accordance with another exemplary embodiment.

FIG. 7 is a cross-sectional view of a valve system for use as an extermination device in accordance with another exemplary embodiment in an unactuated state.

FIG. 8 is cross-sectional view of the valve system of FIG. 7 in an actuated state in which poisonous pressurized fluid is released.

FIG. 9 is a cross-sectional view of a valve system in accordance with another exemplary embodiment that is actuated through the melting of the trigger member.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a valve system 10 that is capable of releasing a pressurized fluid 62 for utility in a variety of applications such as a flotation device, a fire suppression system, a heating device, or an extermination device. The valve system 10 includes a housing 12 and a trigger member 30. The trigger member 30 is provided with a degree of structural integrity to prevent the fluid 62 from escaping a container 60 into which the fluid 62 is housed. Upon being subject to a force that causes the trigger member 30 to lose structural integrity, the valve system 10 opens to cause the release of the pressurized fluid 62 for use in the application in which the valve system 10 is implemented.

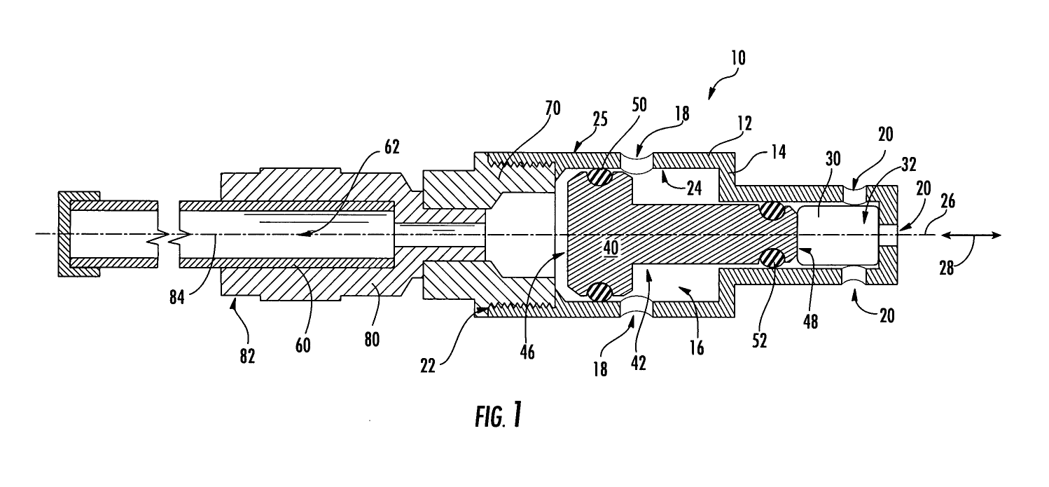

One exemplary embodiment of the valve system 10 is illustrated with reference to FIG. 1. The valve system 10 includes a housing 12 that has an interior 16 into which a trigger member 30 may be located. In the disclosed embodiment, the valve system 10 also includes a plunger 40 that is located in an interior 16 of the housing 12. The plunger 40 engages the trigger member 30, and pressurized fluid 62 is in communication with the housing 12 and acts on a first end 46 of the plunger 40. Force from the pressurized fluid 62 biases the plunger 40 against the trigger member 30. The structural integrity of the trigger member 30 is such that it resists forces imparted thereon by the plunger 40 and essentially causes the position of the plunger 40 to be held stable within the housing 12. The plunger 40 is positioned such that the pressurized fluid 62 is prevented from moving past the plunger 40 and out of a fluid escape aperture 18 of the housing 12. In this manner, the fluid 62 is contained within the valve system 10 and is prevented from exiting therefrom.

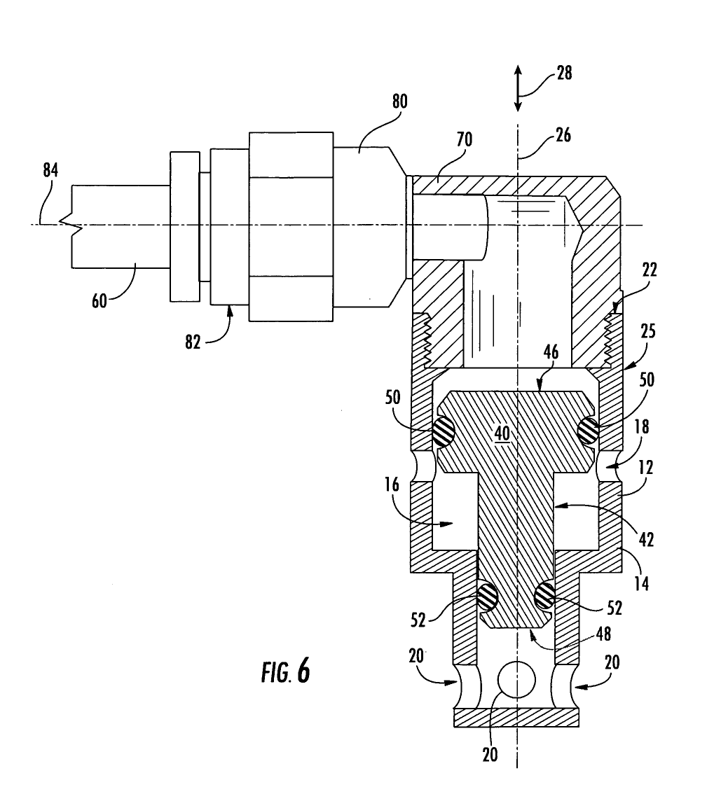

The housing 12 may be made of a variety of materials and is shown in additional detail with reference both to FIGS. 1 and 5. The housing 12 may be made of metal or plastic in accordance with certain exemplary embodiments. The housing 12 may be made of polycarbonate in accordance with one exemplary embodiment. The housing 12 may be generally cylindrical in shape and so as to extend about a longitudinal axis 26. The housing 12 can have a wall 14 that is a single, integral piece that forms the entire housing 12. In other arrangements, the housing 12 may be formed by multiple components that may or may not be formed of the same material. The wall 14 has an inner surface 24 that defines an interior 16 of the housing 12. The outer surface 25 of the wall 14 is rounded and forms a cylindrical outer surface of the housing 12. Although described as being cylindrical in shape, it is to be understood that the outer surface 25 or other portions of the housing 12 need not be cylindrical in shape in accordance with other exemplary embodiments.

The interior 16 of the housing 12 includes two sections that have diameters that are different than one another. The two sections are spaced form one another in the longitudinal direction 28 of the housing 12 that extends along the direction of the longitudinal axis 26. A plunger 40 is located in the interior 16 and may engage the inner surface 24 of the wall 14. The plunger 40 has a first end 46 and a second end 48 that are spaced from one another in the longitudinal direction 28. The diameter of the first end 46 is larger than the diameter of the second end 48 so that pressure applied to the first end 46 is translated into a greater pressure generated by the second end 48. However, it is to be understood that the ends 46 and 48 may be of the same size in other embodiment, and that the size of the second end 48 may be greater than the size of the first end 46 in yet other embodiments. The plunger 40 is illustrated in a first position 42 in FIG. 1. Here, portions of the plunger 40 are located in both of the sections of the interior 16 of the housing 12. Also in the first position 42, the second end 48 engages the trigger member 30. Still further in the first position 42, the plunger 40 prevents the fluid 62 from moving through a fluid escape aperture 18 defined through the wall 14 of the housing 12.

The wall 14 can include a single fluid escape aperture 18 defined therethrough or may include multiple fluid escape aperture 18 defined around the circumference of the outer surface 25 and extending into the inner surface 24. The fluid escape apertures 18 may be four in number in one exemplary embodiment and can be spaced equal distance about the outer surface 25 from one another. In other arrangements, the fluid escape apertures 18 may be from 1-5, from 5-10, from 10-20, or up to 30 in number and may be equally or unequally spaced from one another about the outer surface 25. Although shown as being located at the same position in the longitudinal direction 28, other arrangements are possible in which one or more of the fluid escape apertures 18 are spaced from one another in the longitudinal direction 28. The fluid escape apertures 18 may have a circular cross-sectional shape.

Pressurized fluid 62 is stored within a container 60 that is in fluid communication with the interior 16 of the housing 12. The pressurized fluid 62 acts against the first end 46 of the plunger 40 and the engagement between the plunger 40 and the inner surface 24 may be made so as to prevent the fluid 62 from passing between these two components. In this regard, the plunger 40 and the inner surface 24 may be manufactured with a tolerance tight enough to prevent pressurized fluid 62 from moving therebetween yet loose enough to allow the plunger 40 to move with respect to the inner surface 24. In other arrangements, the plunger 40 may include a first O-ring 50 that seats within a depression of the plunger 40 and extends around the entire circumference of the plunger 40. The O-ring 50 is a deformable seal that engages the inner surface 24 and forms a seal at this point to prevent pressurized fluid 62 from moving past the first O-ring 50. The size and engagement of the first O-ring 50 to the inner surface 24 may be selected to allow the necessary seal to be formed yet loose enough to allow the plunger 40 to be moved relative to the inner surface 24. Further, although a single O-ring 50 is used to prevent the fluid 62 from moving through the fluid escape aperture 18, it is to be understood that the plunger 40 can be provided with two or more O-rings in other arrangements to prevent this fluid propagation.

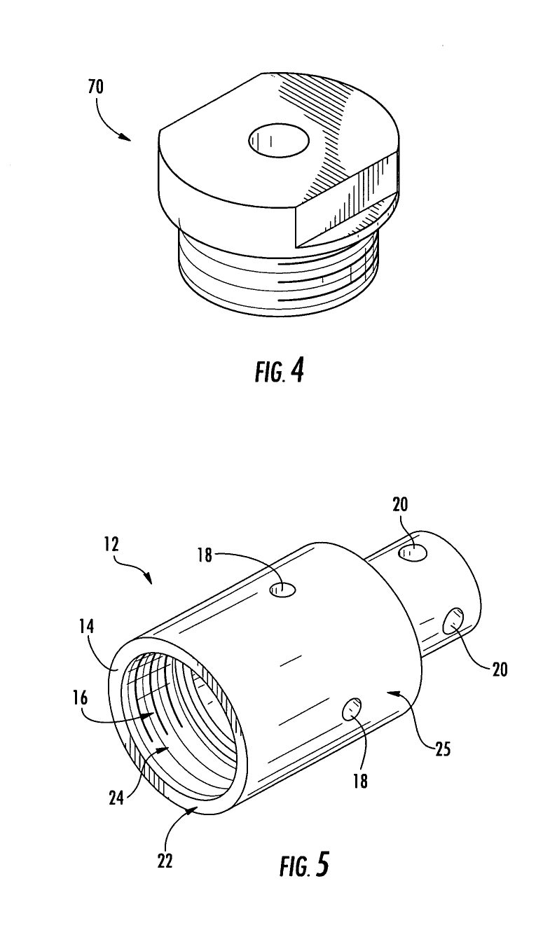

The section of the interior 16 that includes the first O-ring 50 in the first position 42 as shown in FIG. 1 is defined on one end by a step of the wall 14 that extends in the radial direction of the housing 12. An end 22 of the housing 12 proximate to this step is open. Internal threading may be disposed on the inner surface 24 of the wall 14 from the step to the end 22. Exterior threading on a cap 70 can engage the internal threading of the housing 12 in order to effect releasable connection of the cap 70 to the end 22 of the housing 12. The cap 70 is illustrated with reference to both FIGS. 1 and 4. However, in other arrangements, the cap 70 need not be present or can be permanently or removably connected to the housing 12 in a variety of manners. The cap 70 can be made of plastic, metal, or any other material. In accordance with one exemplary embodiment, the cap 70 is made of polycarbonate. The cap 70 can have an outer surface that is cylindrical in shape. Further, the outer surface of the cap 70 can have flat, planar portions that are 180° opposite from one another and are used to receive a wrench or other turning instrument for use in rotating the cap 70 when insertion or removal is desired. The interior of the cap 70 is hollow and an opening is disposed completely through the cap 70 along its longitudinal axis.

With reference to FIG. 1, a fitting 80 engages the cap 70. The fitting 80 can be made of a variety of materials such as metal or plastic, and can be polycarbonate in accordance with one exemplary embodiment. The fitting 80 has an outer cylindrical surface 82 that extends around a longitudinal axis 84. A portion of the outer cylindrical surface 82 includes external threads that engage internal threading located on an inner surface of the cap 70. The fitting 80 can thus be removably connected to the cap 70 by way of this treaded engagement. In other embodiments, the fitting 80 need not be present or may be attached either permanently or removably to the cap 70 in a variety of manners. As shown in FIG. 1, when engaged, the longitudinal axis 84 of the fitting 80 is aligned with the longitudinal axis 26 of the housing 12 so that these two components are co-axial with one another. Although described as having an outer cylindrical surface 82, it is to be understood that the entire outer surface of the fitting 80 need not be cylindrical in certain embodiments. For example, one or more planar faces may be defined on the outer surface of the fitting 80 to aid the user in grasping or turning the fitting 80 with a wrench or other device when engagement and disengagement is desired.

The pressurized fluid 62 is stored within a container 60 that may be incorporated into the valve system 10. The container 60 may be a plastic tube in one embodiment so as to have a degree of flexibility imparted therewith. Alternatively, the container may be made out of non-flexible plastic or out of metal in other arrangements. An end of the container 60 is crimped to prevent the fluid 62 from escaping from at this point. A tube cap or any member may be used to seal the end of the container 60 to prevent fluid from escaping in this regard. The opposite end of the container 60 is open and is received within the fitting 80. The outer surface of the container 60 can be frictionally fit into the interior of the fitting 80. In other arrangements, the open end of the container 60 can be attached to the fitting 80 in a variety of manners. With the disclosed arrangement, the interior of the container 60 is in communication with the interior 16 of the housing 12 such that the pressurized fluid 62 will flow through the open end of the container 60, through the fitting 80, through the cap 70, into the interior 16 of the housing 12 via the open end 22, and against the first end 46 of the plunger 40 or against both the first end 46 and the first O-ring 50 if the O-ring 50 is present and used to aid in sealing of the valve system 10.

The fluid 62 may be Freon or a Freon substitute in certain exemplary embodiments. The fluid 62 may be at a pressure from 70-90 psi when in the container 60 in the unreleased state. In other arrangements, the fluid 62 may be pressurized to a pressure from 40-60 psi, from 90-130 psi, from 130-250 psi, or up to 500 psi in accordance with different exemplary embodiments when in the container 60 in the unreleased state. The fluid 62 may be a gas or a liquid when in the container 60 in the unreleased state, and its phase may change or may remain the same when released and vented through the fluid escape aperture 18. The fluid 62 may be a refrigerant such as propane, ammonia, carbon dioxide or a non-halogenated hydrocarbon in certain embodiments. The fluid 62 may be neon, oxygen, argon, nitrous oxide, ethylene, or helium in accordance with other exemplary embodiments. Further, the fluid 62 may be a mixture of one or more substances.

The position of the plunger 40 is held in the first position 42 due to engagement of the second end 48 of the plunger 40 with the trigger member 30. With such an arrangement, the pressurized fluid 62 remains trapped within the container 60, fitting 80, cap 70, and housing 12 thus representing a charged state of the valve system 10. The trigger member 30 is in a first state 32 as shown in FIG. 1. In this regard, the trigger member 30 is a solid material that has enough structural integrity to resist forces imposed thereon by the second end 48 due to the charged state of the valve system 10. The trigger member 30 may be made of a material that causes it to lose structural integrity upon being contacted or subjected to a particular element. For example, the trigger member 30 may be made of a material that dissolves in water, melts when heated to a particular temperature, melts when cooled to a particular temperature, or that is edible and consumed when encountered by mammals such as rodents or insects such as termites.

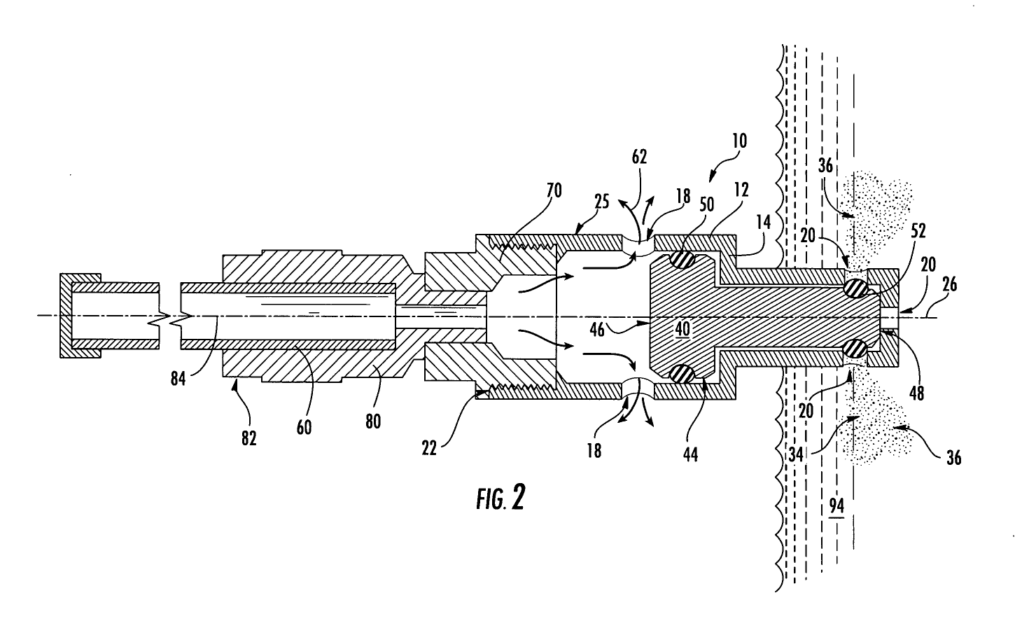

With reference now to FIG. 2, the valve system 10 includes a trigger member 30 that dissolves upon engagement with water. The trigger member 30 may be made of sodium chloride, potassium permanganate, potassium nitrate, copper(II) sulfate, corn starch, and/or flour in accordance with certain exemplary embodiments. One or more water inlets 20 can be defined through the wall 14 in order to cause the trigger member 30 within the interior 16 to be exposed to the environment outside of the housing 12. Any number of water inlets 20 can be present. For example, from 1-5, from 5-10, or up to 30 water inlets 20 can be included in accordance with other exemplary embodiments. The water inlets 20 may be evenly spaced from one another about the circumference of the outer surface 25 or may be unevenly spaced therefrom. Also, some or all of the water inlets 20 can extend through the wall 14 so as to be perpendicular to the longitudinal axis 26. One of the water inlets 20 extends through the wall 14 in an orientation parallel to the longitudinal axis 26. In this regard, the water inlet 20 that extends through the end of the housing 12 is co-axial with the longitudinal axis 26. However, in other embodiments one or more water inlets 20 can be parallel to the longitudinal axis 26 but spaced therefrom so that the longitudinal axis 26 does not extend through the water inlets 20.

The valve system 10 may be positioned so that a portion of the housing 12 is immersed in water 94. For example, the valve system 10 can be placed into a body of water such as a river or pool. Water 94 will flow through the one or more water inlets 20 and engage the trigger member 30. The trigger member 30 will begin to dissolve upon contact with the water 94. This process will cause the trigger member 30 to move from the first state 32 to a second state 34 in which the structural integrity of the trigger member 30 is less than when in the first state 32. Dissolving of the trigger member 30 will cause the strength of the trigger member 30 to weaken as more and more of the material making up the trigger member 30 breaks up and turns either into a liquid or is reduced significantly in size. The trigger member 30 will break up into dissolved portion 36. While the trigger member 30 is dissolving, the force exerted on the trigger member 30 by the plunger 40 will remain. Once the structural integrity of the trigger member 30 has sufficiently weakened, the force exerted by the pressurized fluid 62 on the plunger 40 will cause the plunger 40 to be moved in the longitudinal direction 28 so that it will move with respect to the housing 12, container 60, cap 70, and fitting 80 in the direction towards the end of the housing 12 opposite end 22. Movement of the plunger 40 will cause the dissolved portions 36 to be expelled from the interior 16. Alternatively, the dissolved portions 36 may simply be compressed within the interior between the second end 48 and the end of the housing 12, or the dissolved portions 36 may be subjected to both a combination of expulsion and compression.

Transfer of the trigger member 30 from the first state 32 to the second state 34 allows the plunger 40 to be moved from the first position 42 shown in FIG. 1 to the second position 44 shown in FIG. 2. Longitudinal movement of the plunger 40 will cause the first O-ring 50 to be likewise moved in the longitudinal direction 28. The first O-ring 50 will be moved past the fluid escape apertures 18 in the longitudinal direction 28 so as to be located in the longitudinal direction 28 between the fluid escape apertures 18 and the water inlets 20. The fluid escape apertures 18 are now open to the interior 16 of the housing 12 when the plunger 40 is moved to the second position 44. The pressurized fluid 62 will flow through the fluid escape aperture 18. The valve system 10 can be constructed so that it is a single use device. In this regard, the valve system 10 will move from the charged state to the uncharged state and will not be capable of being returned to the charged state. In other arrangements, one can reinsert pressurized fluid 62 into the container 60 and install a new trigger member 30 so that the valve system 10 can be recharged and hence reused a subsequent time.

The plunger 40 may include a second O-ring 52 that is carried by the plunger 40 and located closer to the second end 48 than the first O-ring 50 in the longitudinal direction 28. The second O-ring 52 is positioned between the fluid escape aperture 18 and the water inlet 20 when the plunger 40 is in the first position 42. The second O-ring 52 may function to prevent water 94 from moving through the interior 16 of the housing 12 and out of the fluid escape aperture 18. Once the plunger 40 moves to the second position 44, the second O-ring 52 may be located within one or more of the water inlets 20 to seal these water inlets 20 to prevent water 94 from moving through the interior 16 and into the fluid escape aperture 18. The second end 48 may be urged against the inner surface 24 of the wall 14 of the housing 12 to seal any water inlets 20 that may be present through the terminal end of the housing 12. Further, the release of the pressurized fluid 62 into the bladder 90 may cause the plunger 40 to eventually be depressurized since the force of the fluid 62 is now dissipated to the interior of the bladder 90. Movement of the second O-ring 52 into longitudinal alignment with the water inlet 20 may cause the second O-ring 52 to expand to be located within the water inlet 20 thus causing the second O-ring 52 to grab onto the housing 12. However, it is to be understood that the second O-ring 52 need not be present in other arrangements and need not be located at the same longitudinal distance as the water inlets 20 in accordance with other exemplary embodiments.

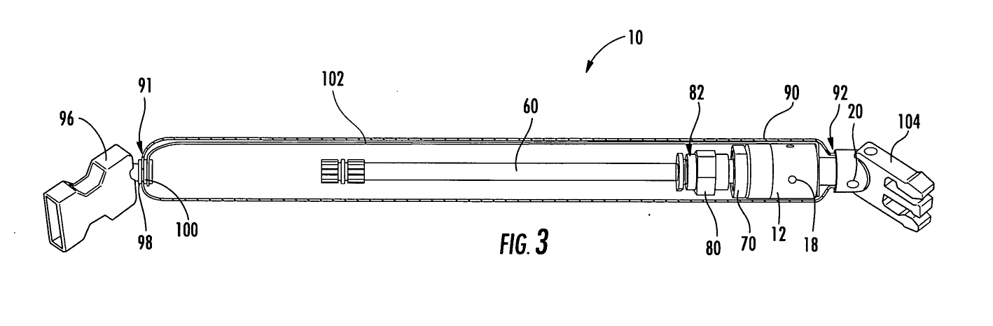

The valve system 10 can be configured as a life preserver in accordance with one exemplary embodiment. With reference now to FIG. 3, a bladder 90 that can be inflated may be incorporated into the valve system 10. The bladder 90 may be made from a variety of materials such as polyurethane or polyvinylchloride or other material that is relatively gas impermeable. In accordance with one exemplary embodiment, the bladder 90 may be made completely or partially of biaxially-oriented polyethylene terephthalate, and may be made of a type having a trade name of MYLAR®, supplied by United States Plastic Corporation having offices located at 1390 Neubrecht Road, Lima, Ohio USA. The open ends of the bladder 91 and 92 can be heat sealed to effectively close the bladder 90. The end 92 may be attached and sealed to the outer surface 25 of the housing 12, and end 91 may be sealed between two nylon washers 98 and 100 of a clip piece 96. The clip piece 96 has a portion that is located within the interior of the bladder 90 and that extends beyond and is outside of the bladder 90. The nylon washer 98 may be located outside of the bladder 90, and the nylon washer 100 can be located in the interior of bladder 90. The nylon washers 98 and 100 may be grooved in certain embodiments to facilitate connection with the end 91 of the bladder 90. A nylon strap 102 may be attached to the portion of the clip piece 96 that is inside of the bladder 90 and to the housing 12 or other member that is likewise attached to the housing 12. In some embodiments, the nylon strap 102 is on this end disposed between the cap 70 and the housing 12, but it is to be understood that the nylon strap 102 on this end can be attached to any portion of the valve system 10 such as the container 60, cap 70, fitting 80, housing 12, clip piece 104 or any combination therewith. For example, the nylon strap 102 on this end may be located between the housing 12 and the clip piece 104. The nylon strap 102 on the opposite end may be attached to the portion of the clip piece 96 that is closer to the container 60 than the portion of the clip piece 96 to which the nylon washers 98 and 100 are attached. The nylon strap 102 functions to provide structural stability to the valve system 10 to prevent the clip piece 96 from being pulled away from the housing 12 so that it tears the bladder 90. The user may place the valve system 10 around his or her neck or other body part such as the waist, arm, chest, or leg.

A second clip piece 104 is attached to the housing 12. The user can wrap the bladder 90 about his or her body until the clip pieces 96 and 104 are proximate to one another and then engage same. The user can detach the clip pieces 96 and 104 when the valve system 10 is no longer needed. Both of the clip pieces 96 and 104 are angled in order to facilitate ease of attachment. In this regard, the clip piece 96 has a portion that is attached to the nylon washers 98 and 100 that is coaxial with the longitudinal axis 26. The portion of the clip piece 96 that is capable of engagement with clip piece 104 is angled to the coaxial portion of the clip piece 96. Theses portions of the clip piece 96 may be located at an angle from 10°-20°, from 20°-30°, from 30°-60°, or up to 90° to one another. The various portions of the clip piece 96 may be integrally formed or may be different pieces that are attached to one another. For example, the portion that is coaxial with the longitudinal axis 26 may be made of metal and can be a bolt in configuration, while the portion that is angled to the longitudinal axis 26 can be made of plastic.

In a similar manner, clip piece 104 has a portion that is coaxial with the longitudinal axis 26 and a portion that is angled thereto. The two portions of the clip piece 104 may be angled at degrees similar to those previously discussed with respect to clip piece 96 and a repeat of this information is not necessary. Further, the angled portions of the clip pieces 96 and 104 may be rigidly attached such that the angle to which the portions of the clip pieces 96 and 104 are disposed is not adjustable. However, in other embodiments one or both of the clip pieces 96 and 104 may be hinged such that the angle between the portions of the clip pieces 96 and 104 may be adjustable. The portion of the clip piece 104 that includes the water inlet 20 may be the portion that is coaxial with the longitudinal axis 26, and the portion of the clip piece 104 that is angled to the longitudinal axis 26 may not include any water inlets in certain exemplary embodiments. The portion of the clip piece 104 that is coaxial with the longitudinal axis 26 may surround the end of the housing 12 and define one or more apertures that are aligned with the water inlets 20 of the housing 12 so that the water inlets 20 are essentially extended to the exterior surface of the device so that water 94 can enter therein. The end 92 of the bladder 90 may be located between the housing 12 and the portion of the clip piece 104 that is coaxial with the longitudinal axis 26 and sealed therein. The clip piece 104 may be a single, integrally formed component or may be made of one or more components that are attached to one another.

Should the user inadvertently fall into a body of water 94 or otherwise come into contact with water 94, the trigger member 30 will be dissolved from the first state 32 to the second state 34. The housing 12 is arranged so that one or more of the water inlets 20 are located outside of the interior of the bladder 90 and exposed to the environment. The water inlets 20 may extend to any exterior surface of the clip piece 104, even those arranged at an angle to the longitudinal axis 26. The water inlets 20 are thus open to the environment in both the attached and unattached states of the clip pieces 96 and 104.

Transition of the trigger member 30 to the second state 34 will cause the fluid 62 to flow out of the fluid escape aperture 18 and into the interior of the bladder 90 at which time the bladder 90 will begin to inflate. The bladder 90 may be coated with a fabric in certain embodiments. Fabric may be incorporated into the bladder 90 that is not airtight so as to allow water or other fluid to move therethrough. As such, the bladder 90 may be made of multiple layers made of different materials and some but not all of the layers need be airtight. The bladder 90 can be configured so that inflation of the bladder 90 will cause the bladder 90 to assume a curved or rounded shape thus accommodating use as a life preserver. Further, the nylon strap 102 may function to shape the bladder 90 into a curved or otherwise rounded orientation upon inflation. The container 60 may be made of a flexible material to allow the valve system 10 to be wrapped in a circular orientation around the user when worn and when the bladder 90 is deflated. Once the valve system 10 is no longer needed, the user may detach the clip pieces 96 and 104 from one another in order to remove the valve system 10 from his or her body.

The valve system 10 may be formed into life jackets, life boats, buoys, or other items needed to be inflated when immersed into a body of water 94. The valve system 10 may be configured into a safety ball that inflates to prevent a boat from sinking when the boat becomes swamped in a body of water 94. In other arrangements, the valve system 10 can be formed into a cover, so as to function as an umbrella, when exposed to water 94 in order to inflate the bladder 90 and prevent an object from becoming wet when rain 94 begins to fall. The bladder 90 can be a single compartment or may be made of multiple compartments out of various materials. Further, the bladder 90 can be configured so that upon inflation it takes a variety of shapes such as circular, cylindrical, ring-shaped, or cone shaped.

The valve system 10 may be configured to function such that the only forces acting on the valve system 10 to cause or prevent actuation are the pressure from the pressurized fluid 62 and the structural integrity of the trigger member 30. The valve system 10 may be arranged so that it does not have any mechanical springs or electronics incorporated therein to effect actuation. As such, the valve system 10 may be arranged so that a spring mechanism and/or an electronic system is not present in order to actuate the valve system 10 to allow the plunger 40 to be moved to allow the fluid 62 to be released through the fluid escape aperture 18.

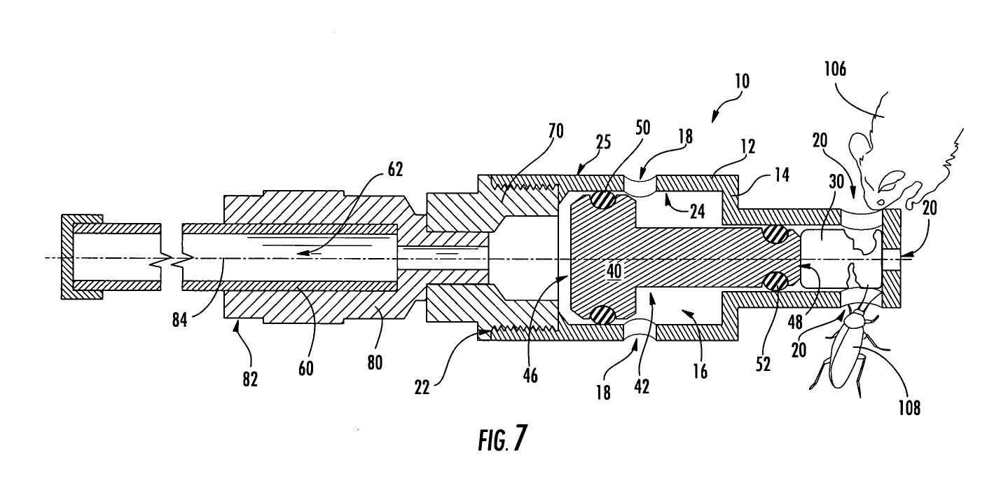

An alternative exemplary embodiment of the valve system 10 is illustrated in FIG. 6. Here, the cap 70 is arranged so that it has an opening for communication with the fitting 80 that is perpendicular to the longitudinal axis 26 of the housing 12. The fitting 80 engages the cap 70 and can be retained thereon through a friction fit, treaded engagement, or any other suitable attachment mechanism. The longitudinal axis 84 of the fitting 80 is oriented at a 90° angle to the longitudinal axis 26 of the housing 12. In other arrangements, the longitudinal axis 84 may be oriented at an angle from 10°-35°, from 35°-45°, from 45°-85°, or up to 145° to the longitudinal axis 26. The fitting 80 and hence container 60 can be angled with respect to the other portions of the valve system 10 so that the valve system 10 can be used in applications in which this arrangement is necessary or desirable.

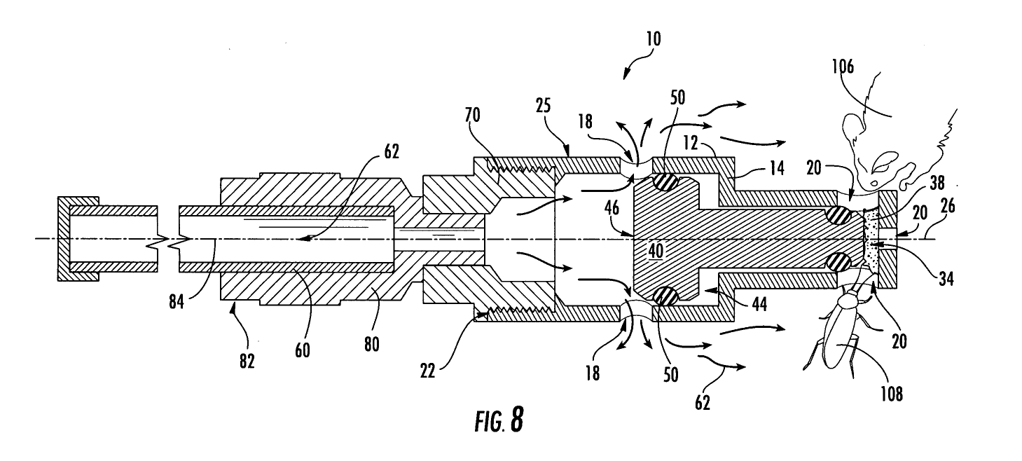

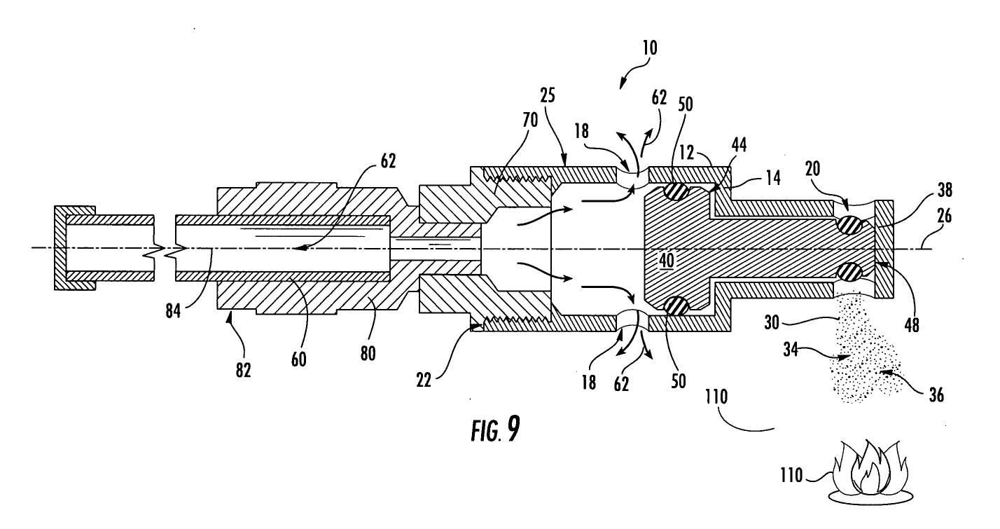

FIGS. 7 and 8 illustrate the valve system 10 as an extermination device. The fluid 62 can be poison or may be a poison mixed with a Freon substitute. The trigger member 30 may be made of a substance that is edible to a mammal 106 such as a bat, rat, squirrel, mouse, mole, or other animal that is proving to be a nuisance to the homeowner. The mammal 106 may consume the trigger member 30. Upon consumption of the trigger member 30 to a sufficient degree, the structural integrity of the trigger member 30 will weaken and the trigger member 30 will move from the first state 32 to the second state 34. Once the necessary degree of structural integrity is lost upon conversion to the second state 34, the plunger 40 will move and crush the remaining trigger member 30 into the crushed trigger member 38 illustrated in FIG. 8. The fluid escape aperture 18 will now be exposed to the interior of the container 60, and the fluid 62 may escape from the fluid escape aperture 18 and kill the mammal 106. The mammal 106 may instead of consuming the trigger member 30 within the housing 12 act to pull the trigger member 30 from the housing 12. This will likewise cause the plunger 40 to move since the second state of the trigger member 30 may be defined as being the removal from the housing 12 and thus complete loss of structural integrity to the valve system 12.

Additionally or alternatively, the valve system 10 may be arranged for the extermination of insects 108 such as ants, termites, or cockroaches. The trigger member 30 may be made of a material such as cellulose when the extermination of termites is desired. The termites 108 may burrow into the trigger member 30 until the structural integrity of the trigger member 30 is compromised thus causing the state of the trigger member to be changed from the first state 32 to the second state 34. At such time, the plunger 40 will move and fluid 62 will be dispensed from the fluid escape aperture 18 which will cause the insects 108 to be killed. The trigger member 30 may be accessed in the variously discussed exemplary embodiments illustrated in FIGS. 7 and 8 by the mammals 106 or insects 108 through the water inlet(s) 20. Although described previously as allowing water to access the trigger member 30, it may be seen that the opening afforded by the water inlet 20 can be sized and shaped so as to allow the mammals 106 or insects 108 to gain access to the trigger member 30 and it is to be understood that the inlet 20 is described as a water inlet 20 for sake of convenience in certain embodiments and that water need not be actually introduced therethrough in other embodiments. As such, as used herein the term water inlet is broad enough to cover a port that allows the access of materials, heat, cold, or animals therethrough in addition to or alternatively to the access of water.

Another application of the valve system 10 is for use as a fire suppressant system. With reference now to FIG. 9, the fluid 62 may include or may be completely made of HALOTRON®, supplied by American Pacific Corporation Halotron Division having offices located at 3883 Howard Hughes Parkway #700, Las Vegas, Nev., USA. The trigger member 30 may be made of a material that melts once subjected to a certain temperature. The trigger member 30 may move from the first state 32 to the second state 34 once subjected to a temperature that is greater than or equal to 135° Fahrenheit. In other arrangements, the trigger member 30 may move to the second state 34 when heated to a temperature that is at least 145° Fahrenheit, 165° Fahrenheit, 200° Fahrenheit, 300° Fahrenheit, or up to 600° Fahrenheit. A temperature source 110, that may be a fire in certain exemplary embodiments, will function to increase the temperature of the trigger member 30 to a pre-designated level so that the trigger member 30 will melt in the second state 34. The plunger 40 will move to expose the fluid escape aperture and the fluid 62 will escape therefrom. The fluid 62 will be directed towards various portions of the room so as to suppress the temperature source 110 and in the case where the temperature source 110 is a fire the fluid 62 will act to extinguish the fire. Although described as being or incorporating HALOTRON®, it is to be understood that the fluid 62 can be any other fire suppressant fluid in other embodiments.

In accordance with other exemplary embodiments, instead of suppressing the temperature source 110, the bladder 90 if incorporated into the valve system may expand to function as a cover, such as an umbrella, to keep an object or person cool once the trigger member 30 melts upon being heated to a particular temperature. The valve system 10 will thus act as a cover to cool a surface, object or person.

The valve system of FIG. 9 may also be used as a heat source. In this regard, when a room reaches a temperature that is below a desired amount, for example when the temperature drops to 200° Fahrenheit, 150° Fahrenheit, 100° Fahrenheit, 50° Fahrenheit, 32° Fahrenheit, 0° Fahrenheit, −50° Fahrenheit, or −100° Fahrenheit, the trigger member 30 may melt and be changed to the second state 34. The fluid 62 can be propane or another fluid capable of generating heat. The fluid 62 may be released through the fluid escape aperture 18 and cause a fire or other heat source to be realized to increase the temperature of the room or other object to which the valve system 10 is associated. The temperature source 110 may be heated by the valve system 10 or the temperature source 110 may still exist and not be directly heated but rather the room or object associated with the valve system 10 may be so heated. Further, the container 60 in such exemplary embodiments may be a supply of propane or other natural gas to afford an essentially continuous supply of heat once the certain pre-designated temperature threshold was reached.

The heat or cold may be inserted through the water inlet 20. In this regard, by making the trigger member 30 directly face the temperature source 110 through the water inlet 20, a faster sensing of the temperature source 110 may be realized through convection or radiation heat transfer to cause the valve system 10 to actuate faster. However, other embodiments are possible in which the trigger member 30 is shielded from the temperature source 110 by the wall 14 and in which the water inlet 20 is instead used as an outlet for the melted trigger member 30 to be dispensed. Again, as previously mentioned with respect to other embodiments, the water inlet 20 need not have water inserted therethrough but is broad enough to cover a port associated with the housing 12 that allows heat or cold to be transferred therethrough.

Various portions of the valve system 10 may be configured in a manner similar to, or be made of materials similar to, that disclosed in U.S. Pat. No. 7,186,158 B1 to Barber et al., the contents of which are incorporated by reference herein in their entirety for all purposes.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A valve system for releasing a pressurized fluid, comprising:
a housing having a wall that defines an interior of the housing, wherein at least one fluid escape aperture is defined through the wall of the housing, and wherein at least one water inlet is defined through the wall of the housing;
a trigger member located in the interior of the housing, wherein the trigger member is made of a water dissolvable material such that that trigger member dissolves upon engagement with water;
a plunger located in the interior of the housing, wherein the plunger has a first position in which the plunger engages the trigger member; and
a container having a pressurized fluid therein, wherein the pressurized fluid acts against the plunger such that dissolution of the trigger member upon engagement with water causes the plunger to be moved from the first position to a second position, wherein the pressurized fluid is capable of exiting through the fluid escape aperture when the plunger is in the second position.

2. The valve system as set forth in claim 1, further comprising:
a cap that engages an end of the housing; and
a fitting that engages the cap;
wherein the container is a tube that is crimped on one end, wherein an opposite end of the container engages the fitting.

3. The valve system as set forth in claim 1, wherein the plunger has a first end and an opposite second end, wherein both the first end and second end of the plunger have a circular shape, wherein the first end of the plunger has a diameter that is larger than a diameter of the second end of the plunger, wherein the pressurized fluid acts against the first end of the plunger when the plunger is in the first position.

4. The valve system as set forth in claim 1, wherein the plunger has an O-ring that engages an inner surface of the wall of the housing, wherein the O-ring is located in a longitudinal direction of the housing between the fluid escape aperture and an end of the container when the plunger is in the first position, and wherein the O-ring is located in the longitudinal direction of the housing between the fluid escape aperture and the water inlet when the plunger is in the second position.

5. The valve system as set forth in claim 4, wherein the plunger has a second O-ring that engages the inner surface of the wall of the housing, wherein when the plunger is in the second position the second O-ring is aligned with the water inlet such that the second O-ring is located at the same position in the longitudinal direction of the housing as the water inlet.

6. The valve system as set forth in claim 1, further comprising a bladder in fluid communication with the interior of the housing, wherein when the plunger moves from the first position to the second position fluid that exits through the fluid escape aperture is received within the bladder and causes the bladder to become inflated, wherein the valve system is a flotation device.

7. The valve system as set forth in claim 1, wherein the fluid is pressurized to a pressure from 70-90 pounds per square inch when in the container when the plunger is in the first position, wherein the trigger member is made of a material selected from the group consisting of sodium choloride, potassium permanganate, potassium nitrate, copper(II) sulfate, corn starch, and flour.

8. A valve system for releasing a pressurized fluid, comprising:
a housing having a wall that defines an interior of the housing, wherein at least one fluid escape aperture is defined through the wall of the housing;
a trigger member located in the interior of the housing, wherein the trigger member is accessible from outside of the housing;
a plunger located in the interior of the housing, wherein the plunger has a first position in which the plunger engages the trigger member and is prevented from moving from the first position due to the structural integrity of the trigger member; and
a container having a pressurized fluid therein, wherein the pressurized fluid acts against the plunger so as to press the plunger against the trigger member, wherein loss of structural integrity of the trigger member causes the plunger to be moved from the first position to a second position, wherein the pressurized fluid is capable of exiting through the fluid escape aperture when the plunger is in the second position.

9. The valve system as set forth in claim 8, wherein the trigger member is made of a water dissolvable material such that the trigger member loses structural integrity upon engagement with water.

10. The valve system as set forth in claim 8, wherein the trigger member is made of a material that melts upon being subjected to a temperature that is greater than or equal to 135 degrees Fahrenheit such that the trigger member loses structural integrity.

11. The valve system as set forth in claim 8, wherein the trigger member is made of a material that is edible by a mammal such that upon being consumed the trigger member loses structural integrity.

12. The valve system as set forth in claim 8, wherein the trigger member is made of a material that is edible by an insect such that upon being consumed the trigger member loses structural integrity.

13. The valve system as set forth in claim 8, further comprising:
a cap that engages an end of the housing; and
a fitting that engages the cap;
wherein the container is a tube that is crimped on one end, wherein an opposite end of the container engages the fitting.

14. The valve system as set forth in claim 13, wherein the housing has a longitudinal axis about which an outer cylindrical surface of the wall of the housing is disposed, wherein the fitting has a longitudinal axis about which an outer cylindrical surface of the fitting is disposed, wherein the longitudinal axis of the housing is oriented at an angle of 90°to the longitudinal axis of the fitting.

15. The valve system as set forth in claim 8, wherein the plunger has an O-ring that engages an inner surface of the wall of the housing, wherein the O-ring is located in a longitudinal direction of the housing between the fluid escape aperture and an end of the container when the plunger is in the first position, and wherein the O-ring moves past the fluid escape aperture in the longitudinal direction of the housing when the plunger moves from the first position to the second position.

16. A valve system for releasing a pressurized fluid, comprising:
a housing having a wall that defines an interior of the housing, wherein at least one fluid escape aperture is defined through the wall of the housing;
a trigger member carried by the housing, wherein the trigger member is accessible from outside of the housing, wherein the trigger member has a first state in which the trigger member has a degree of structural integrity, and wherein the trigger member has a second state in which the degree of structural integrity of the trigger member is less than when in the first state;
a container having a pressurized fluid therein, wherein the pressurized fluid is incapable of exiting through the fluid escape aperture when the trigger member is in the first state, wherein the pressurized fluid is capable of exiting through the fluid escape aperture when the trigger member is in the second state; and
a bladder that is capable of being inflated, wherein when the trigger member transitions from the first state to the second state the pressurized fluid exits through the fluid escape aperture and is received within the bladder and causes the bladder to become inflated.

17. The valve system as set forth in claim 16, further comprising a plunger located in the interior of the housing, wherein the plunger has a first end and an opposite second end, wherein both the first end and second end of the plunger have a circular shape, wherein the first end of the plunger has a diameter that is larger than a diameter of the second end of the plunger, wherein the pressurized fluid acts against the first end of the plunger when the plunger is in a first position, and wherein the second end of the plunger engages the trigger member when the plunger is in the first position, wherein the plunger blocks the fluid escape aperture to prevent the pressurized fluid from exiting through the fluid escape aperture when the plunger is in the first position,
wherein the plunger is moved by the force of the pressurized fluid to a second position when the trigger member is in the second state, wherein the plunger in the second position does not block the fluid escape aperture so as to allow the pressurized fluid to exit through the fluid escape aperture.

18. The valve system as set forth in claim 17, wherein the plunger has an O-ring that engages an inner surface of the wall of the housing, wherein the O-ring is between the fluid escape aperture and an end of the container when the plunger is in the first position, and wherein the O-ring is located between the fluid escape aperture and the second end of the plunger when the plunger is in the second position, and wherein the valve system is a flotation device.
